(19) United States
(12) Patent Application Publication
(10) Pub. No.: US 2021/0094194 A1
(43) Pub. Date: Apr. 1, 2021

(54) METHOD AND TOOL FOR DISCONNECTING A LINE SPLICE

(71) Applicant: Sean T. Smith, Newcastle, CA (US)

(72) Inventor: Sean T. Smith, Newcastle, CA (US)

(21) Appl. No.: 17/029,940

(22) Filed: Sep. 23, 2020

Related U.S. Application Data
(60) Provisional application No. 62/906,519, filed on Sep. 26, 2019.

(51) Int. Cl. B26B 17/02; B25B 7/02; B25B 7/12; E21C 35/197

(52) U.S. Cl. CPC B26B 17/02; E21C 35/197; B25B 7/12; B25B 7/02

(57) ABSTRACT

A sleeve is made up of two halves which in one embodiment are identical. The sleeve includes a channel extending along the length thereof, which is sized to receive a line therein, which line is to be removed from a splice. The sleeve includes a shim on an end thereof which is sized to fit into an end of the splice, with a tip of the shim pushing back jaws of the splice to remove the line from the splice. A casing fits over the sleeve halves to hold them together. This casing includes a first half and the second half which are pivoted together about a pivot joint. The tool including the casing and sleeve halves can slide along the line to allow the tip of the shim to fit into the end of the splice and push back the jaws to release the line.

### CROSS-REFERENCE TO RELATED APPLICATIONS

This application claims benefit under Title 35, United States Code § 119(e) of U.S. Provisional Application No. 62/906,519 filed on Sep. 26, 2019.

### FIELD OF THE INVENTION

The following invention relates to splices in lines such as power lines, and methods and tools for disconnecting the line from such a splice. More particularly, this invention relates to tools which can fit over a line adjacent to a splice in the line, and which can be slid along the line and into an end of the splice to push back jaws therein and cause the splice to release the line, such as for replacing the splice or replacing/repairing a portion of the line, without requiring (or minimizing) cutting of the line.

### BACKGROUND OF THE INVENTION

Electric wire (also referred to as line or cable) often includes splices therein, which allow for segments of wire to be joined together end to end. Such splices can be used in an initial installation of a power line by having the end of one length of wire terminated through a splice to an end at the beginning of another length of wire. Furthermore, when a power line becomes damaged, a splice can be used to cut out a damaged section and to allow for re-joining of ends adjacent to where a damaged portion was removed. When a splice is improperly installed, which is quite common, or if the splice is damaged, it then needs to be cut out (along with some adjacent wire), and a new splice installed.

Splices come in a variety of different detailed forms. Many such splices are elongate structures with an outer housing surrounding a hollow central core. Such splices often include end clasps or other end connectors (also called “jaws”) which allow for secure connection of the splice to adjacent segments of wire, at each end of the splice. One form of clasp can be in the form of a sharp funnel or a series of teeth biased to allow a segment of wire to pass through the end of the splice and past the clasp in an entering direction, but then to have the teeth or sharp small edge funnel engage the wire and resist motion which would tend to remove the wire from the end clasp. A variety of such mechanisms can be provided for such a clasp of a splice, with some examples generally being referred to as “Chinese handcuffs.” Each end of the splice typically has a similar end clasp, but oriented in opposite directions so that each end of the splice easily receives an end of a wire therein, but resists removal of the wires therefrom. Simple splices of this variety are provided by a variety of different companies.

Splices are used in power line repair typically by first identifying a location where an existing line is to be cut (or just remove a damaged section of wire). The damaged section of line has tension removed by putting a bypass tension support spanning the area where the wire is to be cut, so the tension loads of the wire are taken off of the section of wire where the wire is to be cut, and are transferred to this bypass support (which can be a heavy segment of rope, chain or cable). An electrical bypass is also typically added, to maintain continuity of the electric circuit pathway of the line (along with the hoist that transfers the physical tension).

Once this bypass support is in place and sufficiently tightened, the wire can be cut. When cutting of the wire is completed, the wire is generally static in location, without releasing dangerous amounts of energy at the moment of severing of the wire. As a next step, a portion of wire to be kept is identified and a new segment of wire is identified and brought near the end of the segment of wire to be kept. A splice is utilized and attached to the end of wire to be kept, as well as onto the new wire. The new wire can then be suspended appropriately, and once fully loaded with tension, the bypass supports (electrical and mechanical) can be removed and the repair is complete.

While the use of splices for wire repair is generally effective, and splices are known to have electric conduction and strength properties which generally match that of segments of wire, this standard repair methodology utilizing splices has some disadvantages, as currently implemented. Some segments of wire can over time have a large number of splices thereon, with the splices close to each other. The splices are not as flexible as the wire itself and have some performance differences, so that it is undesirable to have too many splices too close to each other.

Furthermore, the process of cutting the wire, even when appropriately de-tensioned with a bypass support, can still be a difficult and dangerous process. If residual energy is stored up in the wire associated with the high tension in the wire, the moment of severing the wire will cause release of some of this energy, and can injure the cutting tool or personnel utilizing the cutting tool or nearby personnel. The cutting tool can inadvertently contact one of the bypass supports, leading to a very dangerous situation. Often such repairs are done while elevated high above ground, and the risk that forces being released may cause a fall is not insignificant. Accordingly, a need exists and it would be beneficial if wires could be repaired, at least on occasion, without requiring cutting, and without requiring additional splices to be placed in a line.

### SUMMARY OF THE INVENTION

With this invention a method and tool are provided which allow an existing wire splice to be disconnected from a wire and especially a power line wire. Utilizing such a tool, cutting of the wire (also called a “line” or “cable”) and/or the splice is no longer required. Furthermore, repair can be done in an area where a splice already exists, and it is not required that additional splices be placed in the wire. Rather, one splice might just be replaced with another new splice (or a splice could be reused). Often, a splice becomes damaged when removed, or is no longer approved/suitable for its location, so that it is beneficial to utilize a new splice and recycle the old one. No damage is done to the wire or splice by this system and method, like the prior systems.

The tool of this invention, in the embodiment disclosed herein, includes two sleeve halves with each sleeve half having a similar form. The sleeve halves each have a portion f a central channel passing through a center thereof. This channel is sized to match (with a loose fit) a diameter of the wire that is currently held by the splice to be removed. When the two sleeve halves come together, they make a full tubular sleeve around the wire. Generally, these two halves have a shim end extending to a thin tip and a body end which has a greater diameter than the shim end. The body preferably ends at a pair of shoulders on at least one end of the body, with these shoulders defining the greatest diameter portion of the body between the two shoulders. The two sleeve halves could be coupleable together through some form of fastener.

Preferably a casing is provided which has a first half and a second half, which pivot together about a hinge and have an inner chamber which supports the body of the sleeve halves therein when they are placed together surrounding the wire. The casing thus acts as a form of fastener to hold the sleeve halves together. When the casing is closed, by a rotation of the first half and second half about the hinge, the bodies of the two sleeve halves are held securely within the inner chamber of the casing.

The shim end and tip extend out of one end of the casing. The other end of the casing provides an abutment surface which is generally flat and oriented in a plane generally perpendicular to the central channel and the orientation of the wire when the sleeve halves are placed upon the wire. If desired, the casing can have a clasp which keeps the first half and second half of the casing held securely together. If desired, the casing can be reversible, to hold the sleeve halves in two different orientations.

The tip of the shim end is sized to be just slightly greater in diameter than the wire, and having a lesser diameter than the ends of the housing of the splice, so that the tip of the tool (once the two sleeve halves have been placed upon the wire and the casing has been placed over the sleeve halves to hold them together), can fit between the wire and the outer housing of the splice, at one end of the splice. A user then slide the tool (or utilizes a hammer or other impact tool to strike the abutment surface) into the splice. The tip of the shim end of the tool is moved/driven into the annular space between the wire and the housing of the splice to push back the jaws or other clasps. The tip end of the shim is formed of sufficiently hard/strong material that it can break the hold of the jaws of the splice upon the wire, releasing the wire from the splice.

Use of this invention can involve first identifying a location where a wire is to be replaced, and where a splice is already in place. This splice is typically removed along with a section of wire which is to be removed. A junction between the side of the splice to be removed and wire which is to be kept is identified as the end of the splice to be separated from the wire. If needed, the wire is de-tensioned utilizing known wire de-tensioning techniques, such as utilizing a tension bypass support and an electrical bypass support.

The two sleeve halves are placed over the wire to be kept, and oriented facing toward the end of the splice to be removed from the wire. The casing is then closed over the two sleeve halves to hold them together (or some other fastener is utilized). Finally, the tool is slide along the wire (or an abutment surface of the casing is struck with a hammer), moving/driving the tip of the shim end of the sleeve halves along the wire and into the splice to release the jaws of the splice and separate the wire from the splice.

A new segment of wire (if needed or desired) and a new splice (if desired) is then utilized using known techniques, to secure the new splice and the new wire to the end of the existing wire to be kept (after removal of the tool by reversing the attachment process). Typically, the existing wire on both sides of the splice are left undamaged and can be reused, as well as reuse of the splice in many instances, unlike prior art systems and methods. Finally, any bypass support which was utilized can be removed and tension transferred back to the wire to be kept, the new splice and the new wire. One will note from this method that no cutting (or less and simplified cutting) of the wire is needed, removing the risk of cutting bypass supports. Furthermore, the number of splices within a power line is not magnified, but rather kept constant (or reduced).

### OBJECTS OF THE INVENTION

Accordingly, a primary object of the present invention is to provide a tool for releasing a splice from a line that is coupled to the splice.

Another object of the present invention is to provide a method for removing an end of a line from a splice, without requiring cutting of the line.

Another object of the present invention is to provide a tool which can be assembled over a line and slide along the line, and which includes a shim which can fit into an end of the splice to push back jaws of the splice and release a line from the splice.

Another object to the present invention is to provide a tool which allows for replacement of a section of power line or other line without requiring cutting of the line.

Another object of the present invention is to provide a tool and method for releasing a conductor line from a splice within the line.

Another object of the present invention is to simplify the process involved in making various repairs to a power line.

Another object to the present invention is to provide a tool for releasing a line, such as a power line, from a splice, which tool can be fitted with different size sleeve inserts to allow the tool to work with multiple different gauges of line and sizes of splices.

Another object to the present mention is provide a tool for releasing a line from a splice which tool utilizes multiple identical parts so that a total unique part count for the tool is minimized for ease and economy in manufacturing the tool.

Other further objects of the present invention will become apparent from a careful reading of the included drawing figures, the claims and detailed description of the invention.

### BRIEF DESCRIPTION OF THE DRAWINGS

FIG. 1 is a top plan view of the tool of this invention mounted upon a line adjacent to a splice and ready for use in pushing back jars within the splice to release the line from the splice.

FIG. 2 is a top plan view similar to that which is shown in FIG. 1, but with a casing of the tool shown open after sleeve halves have been inserted into the casing and upon a line, and showing the line upon which the sleeve halves have been placed, along with a splice holding the line to another line, with the splice shown in full section, and showing a shim of the tool inserted into the splice and pushing back jaws for releasing of the splice from the line according to a method of this invention.

FIG. 3 is a perspective exploded parts view of that which is shown in FIG. 1, and further revealing how different portions of the tool are oriented relative to the line which is to be removed from the splice, by utilizing the tool.

FIG. 4 is a top plan view of the sleeve half of the tool of FIGS. 1-3.

FIG. 5 is a side elevation view of that which is shown in FIG. 4.

FIG. 6 is a bottom plan view of that which is shown in FIG. 4.

FIG. 7 is a bottom plan view of that which is shown in FIG. 4, and with a line residing within a channel of the sleeve half depicted therein.

FIG. 8 is a rear elevation view of a pair of sleeve halves of FIGS. 4-7 shown together upon a line passing through channels thereof.

FIG. 9 is a front elevation view of that which is shown in FIG. 8.

FIG. 10 is a bottom plan view of one half of a casing of the tool of FIGS. 1-3.

FIG. 11 is a right side elevation view of that which is shown in FIG. 10.

FIG. 12 is a top plan view of that which is shown in FIG. 10.

FIG. 13 is a left side elevation view of that which is shown in FIG. 10.

FIG. 14 is a rear elevation view of that which is shown in FIG. 10.

FIG. 15 is a front elevation view of that which is shown in FIG. 10.

FIG. 16 is a rear elevation view of the tool of FIGS. 1-3 with the casing shown open and with sleeve halves mounted upon a line and resting within a portion of the casing.

FIG. 17 is a rear elevation view of that which is shown in FIG. 16 and FIG. 1, showing the tool completely assembled and mounted upon a line, ready for use to remove the line from a splice, as depicted in FIGS. 1 and 2.

### DESCRIPTION OF THE PREFERRED EMBODIMENT

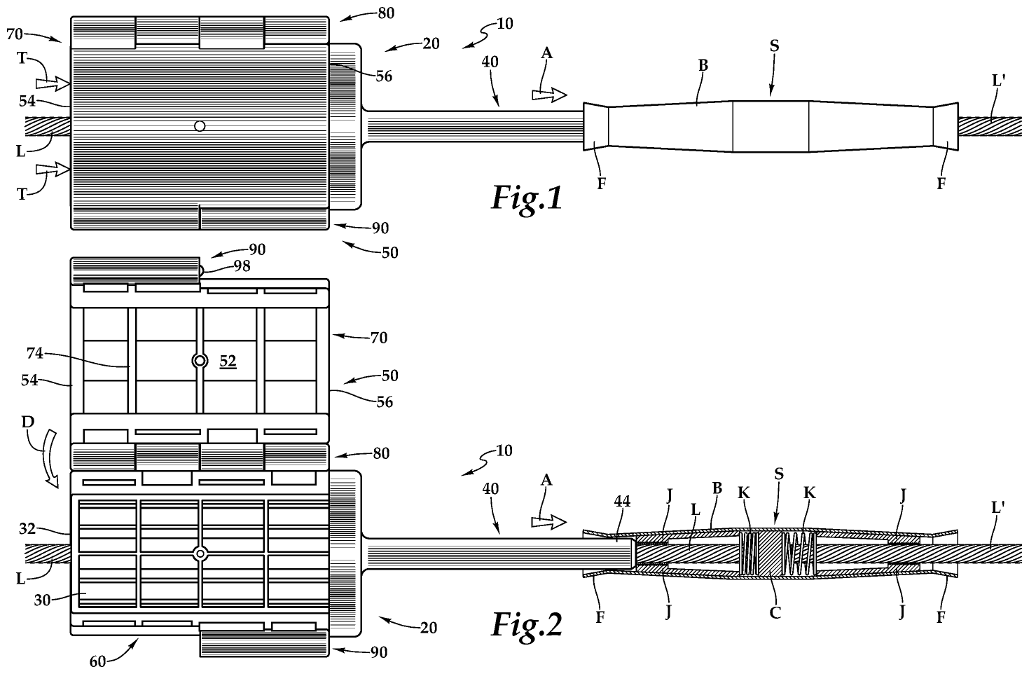

Referring to the drawings, wherein like reference numerals represent like parts throughout the various drawing figures, reference numeral 10 is directed to a splice disconnecting tool (FIGS. 1-3, 16 and 17) which illustrates one example of this invention. The tool 10 fits over a line L adjacent to a splice S so that the tool can have a shim 40 thereof pushed into the barrel B of the splice S to push back jaws J therein and release the line L from the splice S. With such a tool 10, a line L can be removed from the splice S such as to facilitate replacement of a damaged splice S, or to repair a portion of the line L, or otherwise service the line L.

With particular reference to FIGS. 1-3, basic details of the tool 10 are described, according to one embodiment disclosed herein. The tool 10 includes a pair of sleeve halves 20 which together form a sleeve which can fit upon the line L. These sleeve halves 20 are preferably identical to each other for ease of use and to simplify manufacturing. A channel 22 extends along the length of the sleeve halves 20, which channel 22 is sized to fit loosely around the line L when the sleeve halves 20 are brought together. The sleeve halves 20 include a body 30 on a rear end and a shim 40 extending from the body 30 and toward a front distal end. The shim is sized to have a smaller diameter than the body 30 and small enough to fit inside an entry funnel F at an end of the barrel B of the splice S, so that a tip 44 of the shim 40 can push back the jaws J within the splice S to release the line L out from the splice S.

A casing 50 holds the two sleeve halves 20 together within the tool 10. The casing 50 is preferably formed of a first half 60 and the second half 70 which are preferably substantially similar to each other and surround an inner chamber 52 into which the sleeve halves 20 are held. In one embodiment, rails 65, 75 in the halves 60, 70 allow two sleeve halves 20 to be slid thereinto, to securely hold the sleeve halves 20 to the casing 50. Sleeve halves 20 of different sizes can fit within a common casing 50 to accommodate lines L and splices S of different gauges. The first half 60 and second half 70 are preferably pivoted together about a pivot joint 80 of the casing 50. A clasp 90 allows the first half 60 and second half 70 to be releasably held to each other to allow for selective opening and closing of the casing 50.

More specifically, and with particular reference to FIGS. 1 and 2, details of one splice S, with which the tool 10 of this invention can be utilized, are described. This splice S is an elongate generally cylindrical structure having a generally hollow core surrounded by a barrel B (also referred to as a “housing”). This barrel B includes entry funnels F at each end thereof sized to receive a line L therein. Different splices S are sized to work with different line L gauges. Jaws J reside within the splice S adjacent to each entry funnel E These jaws J are biased by springs K referencing against a center stop C in a middle of an interior of the splice S. The springs K keep the jaws J biased toward adjacent entry funnels E However, when a line L is extended into the entry funnel F, the line L can push back the jaws J and to compress the spring K somewhat, until the line L abuts the center stop C.

When the line L is pulled out of the entry funnel F, the spring K pushes on the jaws J and causes the jaws J to move along with the line L. Teeth or other sharp structures on the jaws J engage the line L. The jaws J become wedged against an inside wall of the barrel B of the splice S, which tapers slightly to a narrower diameter adjacent to the entry funnels F. This causes the jaws J to become wedged tighter and tighter between the barrel B and the line L, securely holding the line L to the splice S. The various structures of the splice S are typically formed of electrically conductive material, such as aluminum, so that an electrically conductive pathway can be provided between the line L and the splice S (and over to a second line L′ which is held to an opposite end of the splice S in a similar fashion to the line L). In this way, a conductive pathway is preserved through the splice S as well as structural tension strength of the line L. Some line L is provided for purposes other than supplying an electrically conductive pathway, such as line L used as guy wires, and support cables of various types. In such cases the splice does not need to provide a conductive pathway. While a particular splice S is depicted in FIGS. 1 and 2 to illustrate function of the tool 10 of this invention and a method for use of the tool 10 of this invention, other splices S having a variety of somewhat different geometries and configurations are also known in the prior art. Provided that such other splices include jaws or similar clasp structures which are wedged against the line L to hold the line L within the splice, and can be retracted to disengage from the line L, such other splices could also be utilized with the tool 10 of this invention.

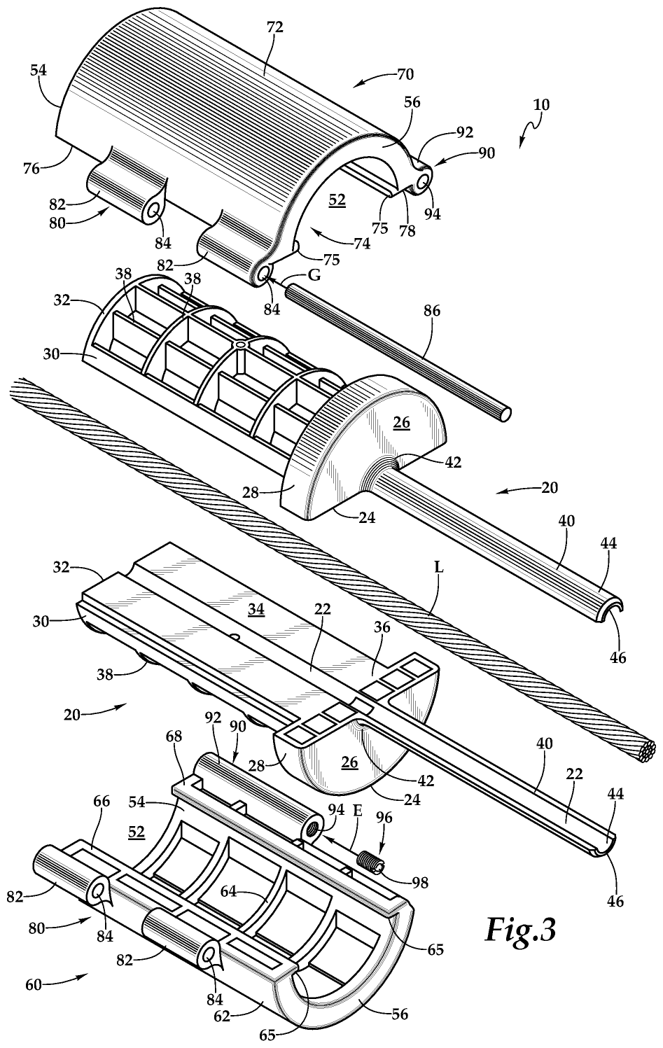

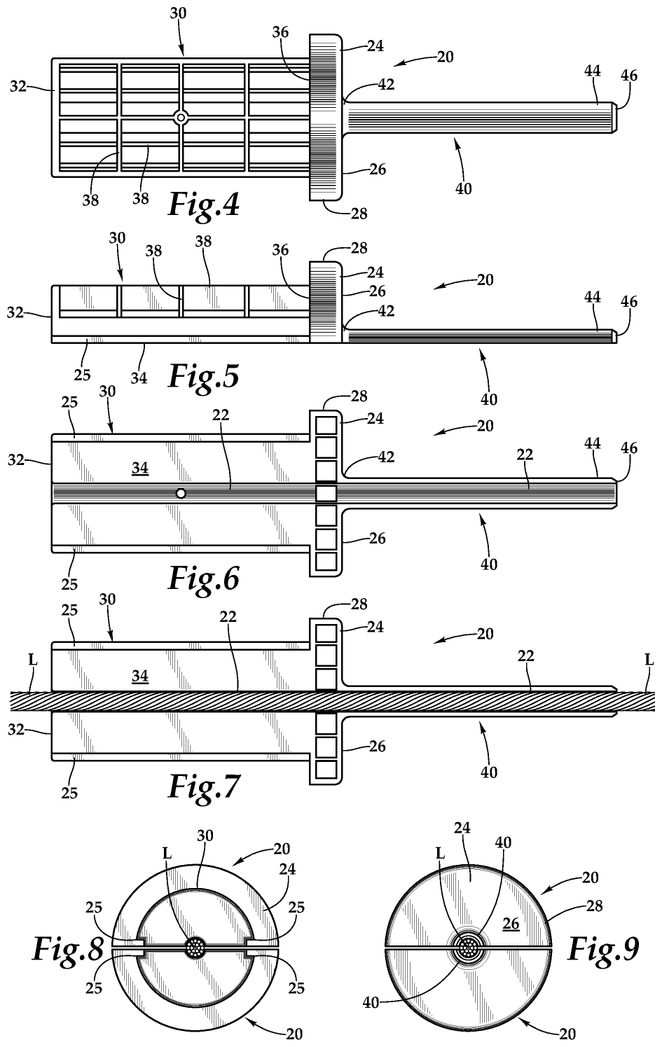

With particular reference to FIGS. 3-9, details of the sleeve half 20 are described, according to one example embodiment. The sleeve half 20 is one of a pair of sleeve halves 20 which are utilized together to form a sleeve around the line L and to provide a shim 40 around the line L for engagement with the splice S and release of the line L by jaws J of the splice S (FIG. 2). These two sleeve halves 20 are preferably identical in form to simplify manufacture and use. Sleeve halves 20 of different sizes can be utilized with the tool 10 to accommodate lines L and splices S of different gauges/diameters/sizes.

In this embodiment, each sleeve half 20 is a unitary mass of substantially rigid material, which could be a high strength plastic material or could be some form of metal, or other material (even potentially wood). In one embodiment, the sleeve half 20 is particularly configured to facilitate its manufacture by injection molding or other casting manufacturing methods. Each sleeve half 20 generally includes a body 30 at a rear end of the sleeve half 20 and a shim 40 (also called a “shim end”) extending away from the body 30 in a forward distal direction.

A channel 22 extends along the length of the sleeve half 20. This channel 22 preferably extends along both the body 30 and the shim 40. The channel 22 is semi-cylindrical in form, so that when the two sleeve halves 20 are brought together, the two channels 22 of the two sleeve halves 20 form a central channel which is a cylindrical pathway extending through the sleeve formed by the two sleeve halves 20 brought together. This central channel 22 has a diameter slightly greater than the diameter of the line L with which the sleeve half 20 is to be utilized. In this way, the sleeve half 20 can slide easily over the line L. When sleeve halves 20 of different sizes are provided, the channel 22 will have differing diameters to accommodate different line L and splice S gauges. Other details of sleeve halves 20 of different sizes will generally be similar to each other.

A shoulder 24 is preferably provided on the sleeve half 20 between the body 30 and the shim 40. The shoulder 24 defines a portion of the body 30 which is slightly greater in diameter than the body 30. The shoulder 24 includes a face 26 extending forward from the shoulder 24 and with a flange 28 defining a greatest diameter portion of the shoulder 24. The shoulder 24 acts as a structure against which a casing 50 of the tool 10 can bear, such as when impact loads are applied to the casing 50 of the tool 10 (along arrow T of FIG. 1) to provide an impulse to the sleeve half 20 through the shoulder 24, to help to dislodge the jaws J from the line L within the splice S, by action of a tip 44 of the shim 40 against the jaws J, in instances where the line L does not become free of the splice S through merely advancing of the sleeve along the line L (along arrow A) and against the jaws J of the splice S.

The body 30 is generally semi-cylindrical in form and extends from the rear wall 32 to a front end 36 adjacent to the shoulder 24. The wall 32 is preferably planar and provides a rear portion of the tool 10 which can be struck if needed, such as with a tap force T (FIG. 1) to assist in pushing back the jaws J within the splice S. The body 30 includes a split wall 34 which is generally planar and within which a portion of the channel 22 is formed. The split wall 34 forms a portion of the sleeve half 20 which is brought adjacent to another split wall 34 of another sleeve half 20 to complete the full sleeve of the tool 10, when two sleeve halves 20 are brought together. Outer ribs 38 define a portion of the body 30 opposite the split wall 34, with the outer ribs 38 providing structural strength for the body 30 and minimizing use of material in construction of the body 30 of the sleeve half 20. As an alternative to the outer ribs 34, this portion of the body 30 opposite the split wall 34 could merely be filled in.

The shim 40 is a generally semi-cylindrical structure extending distally from the shoulder 24 and away from the body 30. The shim 40 has a significantly lesser diameter than that of the body 30 and shoulder 24, sized to fit inside of the entry funnel F of the splice S. The shim 40 also includes a portion of the channel 22 of the sleeve halves 20 extending therealong. The thickness of the shim 40 between the channel 22 and an outer wall opposite the channel 22 is carefully controlled to be small enough to fit between the line L and the entry funnel F of the splice S, so that the shim 40 can fit into this space in the entry funnel F of the splice S to be able to come into contact with the jaws J and push the jaws J back within the splice S (by movement of the shim 40 along arrow A of FIGS. 1 and 2).

The shim 40 is preferably linear in form and extends from a root 42 where the shim 40 connects to the shoulder 24 of the sleeve half 20, to a tip 44 at a distal portion of the shim for the office at the route 42. A bevel 46 is preferably provided in the tip 44 and on a portion of the tip 44 most distant from the channel 22. This bevel 46 can help to fit the shim 40 into space between the line L and the entry funnel F of the splice S, such as in instances where the interface between the line L and the splice S have become damaged somewhat or filled with debris, or with the line L sagging against the inside of the entry funnel F of the splice S, so that an easy fit of the tip 44 of the shim 40 into the entry funnel F cannot be achieved. This bevel 46 preferably causes a distal extremity of the tip 44 to be approximately half of the diameter of portions of the shim 40 slightly back from the distal extremity of the tip 44.

In one embodiment, the two sleeve halves 20 include notches 25 which extend along junctions between the split walls 34 of the sleeve has 20 and the outer ribs 38 of the sleeve halves 20. These notches 25 can about against rails 65, 75 in the halves 60, 70 of the casing 50, to allow for ease in loading of the sleeve halves 20 into the casing 50 in one embodiment. Such notches 25 also keep the sleeve half 20 from rotating relative to the casing 50 of the tool 10, but instead to cause the sleeve halves 20 and the casing 50 to be held together as a unit when utilizing the tool 10.

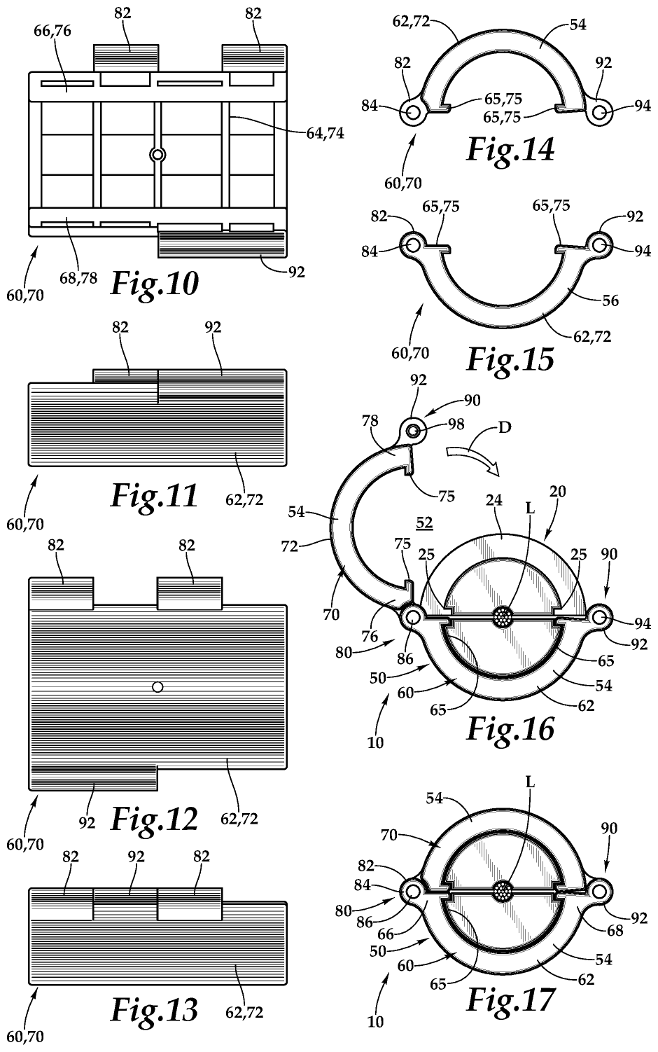

With particular reference to FIGS. 1-3 and 10-17, particular details of the casing 50 are described, according to one disclosed embodiment. The casing 50 serves the function of holding the sleeve halves 20 together to form a single sleeve structure and associated shim structure for pushing back of the jaws J of the splice S and releasing the line L out from the splice S. In this particular embodiment, the casing 50 is provided with an inner chamber 52 sized to receive the sleeve halves 20 partially therein, and with the shim portion of the sleeve formed by the two sleeve halves 20 extending distally from the casing 50 of the tool 10.

The casing 50 includes a rear collar 54 opposite a front collar 56, with the rear collar 54 generally aligning with the rear wall 32 of the sleeve half 20 to provide a rear surface of the tool 10. The front collar 56 can abut against the shoulder 24 and allow for transfer of forces between the casing 50 and the sleeve half 20 to help to drive the shim 40 into a gap between the line L and barrel B at the entry funnel F of the splice S. In this embodiment, the casing 50 is not interlocked with the sleeve half 20. Rather, the sleeve half 20 fits within the inner chamber 52, and in one embodiment can slide axially into and out of the inner chamber 52 by coaction of rails 65, 75 and notches 25 of the halves 60, 70 of the casing 50 and the sleeve halves 20, respectively.

Such attachment allows for axial sliding of the casing 50 relative to the sleeve half 20. Thus, the casing 50 count to some extent act as an attached hammer structure to impart tapping thrust forces against the shoulder 24 of the sleeve half 20, by repeated movement of the casing 50 relative to the sleeve half 20 (along arrow T of FIG. 1). As an alternative, a tool such as a hammer can be utilized to tap (along arrow T) against the rear collar 54 of the casing 50 and rear wall 32 of the sleeve halves 20 to impart such a force as needed to allow the shim 40 to push against the jaws J with the splice S.

The first half 60 is preferably a unitary mass of rigid material, preferably of similar material to that from which the sleeve halves 20 are formed, but alternatively formed of a distinct material from that forming the sleeve halves 20. The first half 60 includes an outer wall 62 defining an outermost radial portion of the tool 10, which typically acts as an interface for grasping of the tool 10 by a hand of a user. Inner ribs 64 are located on a side of the first half 60 opposite the outer wall 62, and defining a portion of walls of the inner chamber 52 of the casing 50. A pivot edge 66 defines one terminus of the outer wall 62 and inner ribs 64. A clasp edge 68 is provided opposite the pivot edge 66.

The pivot edge 66 supports the pivot joint 80 thereon. The clasp edge 68 supports the clasp 90 thereon. Rails 65 extend inwardly from the inner ribs 64 adjacent to both the pivot edge 66 and the clasp edge 68. These rails 65 are linear in form and co-act with the notches 25 in the sleeve halves 20 to allow for one sleeve half 20 to slide into the inner chamber 52 of the casing 50 adjacent to the inner ribs 64 of the first half 60. Sleeve halves 20 of different sizes can be fitted into the inner chamber 52 of the casing 50 and adjacent to the inner ribs 64 of the first half 60, to allow for sleeve halves 20 of appropriate size to be fitted with the casing 54, matching a gauge and/or diameter of the line L and splice S.

The second half 70 is provided along with the first half 60 to form the casing 50. The second half 70 is preferably identical to the first half 60 to simplify manufacture of the casing 50. Thus, the second half 70 includes an outer wall 72 opposite inner ribs 74. A pivot edge 76 is provided opposite a clasp edge 78. Rails 75 extend inwardly from the edges 76, 78 to allow for a sleeve half 20 to be slid into the inner chamber 52 of the casing 50 and adjacent to the inner ribs 74 of the second half 70. The first half 60 and second half 70 act as clamshell halves which can pivot together (along arrow D of FIGS. 2 and 16) to close upon the sleeve halves 20, or to close the sleeve halves 20 together within the casing 50, upon the line L and before use of the tool 10.

With particular reference to FIGS. 1-3 and 10 through 17, details of the pivot joint 80 are described according to one embodiment of this invention. The pivot joint 80 allows for the halves 60, 70 of the casing 50 to articulate relative to each other. This pivot joint 80 includes a pair of knuckles 82 (or some other number of knuckles) which are preferably formed along with the halves 60, 70 extending from the pivot edges 66, 76 thereof. Bores 84 pass through these knuckles 82 to receive a pintle 86 passing through the bores 84 in the knuckles 82, and to allow the halves 60, 70 to rotate about this pintle 86 (along arrow D of FIGS. 2 and 16). The pintle 86 is inserted (along arrow G of FIG. 3) to cause the knuckles 82 of the two separate halves 60, 70 to be brought together to form the pivot joint 80. The pivot joint 80 is shown open in FIGS. 2 and 16, while this pivot joint 80 is shown closed in FIGS. 1 and 17.

With particular reference to FIGS. 1-3 and 10-17, details of the clasp 90 are described, according to this disclosed embodiment. The clasp 90 acts as a form of closure for selectively holding the casing 50 in either a closed position or allowing the casing 50 to be opened. In particular, the clasp 90 includes a barrel 92 formed within and extending from each clasp edge 68, 78 of each half 60, 70 of the casing 50. These barrels 92 include holes 94 extending at least into portions of each barrel 92 near a center of each half 60, 70. For convenience, these holes 94 can pass entirely along the barrels 92 in one embodiment. The barrels 92 preferably extend half of a distance between the rear collar 54 and front collar 56 of the casing 50. When the two halves 60, 70 are brought together by pivot joint 80, these two barrels 92 are aligned oriented with one barrel 92 adjacent to the rear collar 54 of the casing 50 and the other barrel 92 located adjacent to the front collar 56 of the casing 50, and with central portions of each barrel 92 located directly adjacent each other (when the casing 50 is closed).

To allow for latching of these two barrels 92 of the clasp 90 together, a detent assembly 96 is fitted into the hole 94 of one of the barrels 92. The detent assembly 96, in one embodiment, includes male threads on an exterior thereof, which can mate with female threads which can be formed in an interior of the other barrel 92 of the clasp 90, such as by the male threads on the detent assembly 96 being of a self tapping variety, or by utilizing a tapping tool to form female threads in one of the barrels 92. The detent assembly 96 includes a detent ball 98 extending from an exterior end thereof facing the other barrel of the clasp 90. The detent ball 98 is spring loaded and biased toward an outer position extending out sufficiently to engage with and reside within the hole 94 of the barrel 92 of the other portion of the clasp 90. The ball 98 is deflectable by compressing of a spring (or other biasing element) within the detent assembly 96 sufficient to allow the two barrels 92 of the clasp 90 to be separated from each other and to allow for opening of the halves 60, 70 away from each other to open the casing 50.

In use and operation, and with particular reference to FIGS. 1 and 2, details of the method of use of the tool 10 of this invention are described, according to one example. Initially, a user identifies a splice S and associated line L which would benefit from being separated from each other to perform an appropriate line L maintenance activity. Examples of such line L maintenance activity could include replacing of a damaged splice S, replacement or repair of a damage section of line L, and other procedures where removal of a line L from a splice S would be beneficial. A gauge or other size of the splice S and line L are noted and two sleeve halves 20 are selected of similar size to each other and which match the line L and splice S with which the tool 10 is to be used.

The casing 50 is opened, by rotation of the halves 60, 70 away from each other about the pivot joint 80. The sleeve halves 20 are then slid with notches 25 riding along the rails 65, 75 of the halves 60, 70 of the casing 50 to load a sleeve half 20 adjacent to each half 60, 70 of the casing 50. Once the casing 50 has been loaded with sleeve halves 20, the assembled tool 10, still in its open form, is brought adjacent to the line L with a shim 40 of the sleeve half 20 of the tool 10 extending toward the splice S which is to have the line L moved therefrom. The line L is placed residing within one of the channels 22 and one of the sleeve halves 20. The casing 50 is then closed (by rotation along arrow D of FIGS. 2 and 16) until the two halves 60, 70 the casing 50 are adjacent to each other as well as bringing the two sleeve halves 20 together. The clasp 90 will engage, assisting in holding the casing 50 in this closed orientation.

The tool 10 has now been assembled and mounted upon the line L. The tool 10 is thus ready to be used to separate the line L from the splice S. Typically, the line L is in high tension along with the splice S. Tension is taken off of the line L by any of a variety of techniques. For instance, a tension line can be attached to the line L and to the splice S or other portions of the line L′ beyond the splice S (FIGS. 1 and 2) and tightened until tension of the line L is transferred to this tension line, and portions of the line L where it is to be removed from the splice S have had tension removed therefrom.

The tool 10 is then advanced along the line L toward the splice S (along arrow A of FIGS. 1 and 2). The tip 44 of the shim 40 extends into the entry funnel F of the splice S until the tip 44 of the shim 40 impacts the jaws J of the splice S. Further movement of the tool 10 along arrow A causes the jaws J to be pushed inwardly within the splice S, and compressing the spring K. The jaws J are relieved from being wedged against the line L by tapering of the barrel B near the entry funnels F, so that the jaws J can release the line L. If extra force is needed to cause the jaws J to retract within the splice S, a tapping force (along arrow T of FIG. 1) can be applied, such as by sliding motion of the casing 50 against the shoulders 24 of the sleeve halves 20, or tapping of the rear collar 54 and rear wall 32 of the casing 50 and body 30 of the sleeve halves 20 with a tapping tool, such as a hammer or mallet.

Once the jaws J have released the line L, the line L can be linearly retracted from the splice S. Other steps can then be performed depending on the procedure involved, such as removal of the line L′ from the other end of the splice S if the splice S is to be replaced, or substituting of the line L with a separate line if replacement of the line L is to be performed. After appropriate structures have been removed/replaced, a new or original line L can be inserted into a new (or the original) splice S for attachment of the line L to the splice S. Finally, the tension line can have tension thereon released, so that tension returns to the line L and splice S as in the original condition. The procedure is completed. The tool 10 is removed by reversing the above attachment procedure, and remains usable with another line L and splice S in future procedures. Typically a single casing 50 is provided along with sleeve halves 20 in pairs and of different sizes, so that the kit can have appropriate sleeve halves 20 selected for use with the casing 50 to match various gauges of the line L and splice S.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When embodiments are referred to as “exemplary” or “preferred” this term is meant to indicate one example of the invention, and does not exclude other possible embodiments. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1. A tool for removing a splice from an end of a wire, the tool comprising in combination:
a pair of sleeve halves surrounding a central channel sized to receive the wire;
a casing surrounding at least portions of said pair of sleeve halves to hold said pair of sleeve halves together; and
said sleeve halves including a shim end with a tip of said shim end having an annular size greater than a diameter of the wire and less than a diameter of the splice at an end of the splice coupled to the wire.

2. The tool of claim 1 wherein said sleeve halves are semi-cylindrical in form with channel portions therein which together form said central channel.

3. The tool of claim 1 wherein said casing includes a first half and a second half which are hinged together.

4. The tool of claim 3 wherein said sleeve halves each include a body having a larger diameter than said shim end and said tip, and with said body of each of said sleeve halves held together by said casing.

5. The tool of claim 4 wherein said casing includes an inner chamber shaped to receive said the body of each of said sleeve halves therein while held together and upon the wire.

6. The tool of claim 5 wherein said sleeve halves include a shoulder between said body and said shim end, said shoulder having a larger diameter than said body and a larger diameter than said shim end.

7. The tool of claim 1 wherein said tip of said shim end includes a bevel on a surface thereof, causing a diameter of said shim end to taper to a lesser amount approaching a distal terminus of said tip.

8. The tool of claim 1 wherein said casing includes a first half and a second half, said first half and said second half of said casing being substantially identical to each other.

9. The tool of claim 1 wherein said sleeve halves are identical to each other.

10. The tool of claim 1 wherein said casing includes a first half and a second half which are hinged together, and wherein said first half and said second half include complementary portions of a clasp, engageable together to close said casing upon said sleeve halves to hold said pair of sleeve halves together.

11. A method for removing a splice from a wire, the method including the steps of:
placing a tip of a shim between the wire and an end of the splice adjacent to the wire, with the tip pointing along a line generally parallel with the wire, the shim provided as two shim ends of two sleeve halves with a hollow channel therein sized at least as large as a diameter of the wire; and
moving the tool to drive the tip of the shim between the wire and the end of the splice, to push back and separate jaws of the splice from the wire.

12. The method of claim 11 wherein said placing step includes the sleeve halves each including a body having a larger diameter than a diameter of the shim end.

13. The method of claim 12 wherein said placing step includes a casing having an inner chamber sized to receive each body of the two sleeve halves therein, and the casing closable to hold each body of the two sleeve halves therein and with the shim extending out of an end of the casing to the tip.

14. The method of claim 13 wherein said placing step includes the casing having an abutment surface facing in an opposite direction from a direction in which the shim extends away from the casing toward the tip.

15. The method of claim 14 wherein said placing step includes the tip having an annular form.

16. The method of claim 14 wherein said placing step includes the tip having a diameter which is an amount larger than a diameter of the wire and smaller than a diameter of an end of the splice in which the wire is located.

17. The method of claim 11 wherein said moving step includes striking the tool on a portion of the tool opposite the shim, to drive the tip of the shim between the wire and a housing of the splice to push back jaws within the splice and release the wire from the splice.

18. A tool for removing a line from a splice, the tool comprising in combination:
a sleeve surrounding a majority of a channel, said channel sized to contain at least a portion of the line therein;
a shim extending from an end of the sleeve and including an end of the channel therein;
said shim terminating a tip; and
said tip of said shim sized to fit into an end of the splice to push back jaws of the splice and release the line from the splice.

19. The tool of claim 18 wherein said sleeve is made up of two parts, each said part of said sleeve having a portion of said shim thereon and a portion of said channel therein.

20. The tool of claim 19 wherein a casing holds said two parts of said sleeve together, said casing selectively closable upon said two parts of said sleeve to facilitate mounting of said two parts of said sleeve upon the line, with the line passing through said channels and said two parts of said sleeve.
